(19) United States
(12) Patent Application Publication
(10) Pub. No.: US 2007/0074168 A1
(43) Pub. Date: Mar. 29, 2007

(54) Automated step type determination

(75) Inventors: Cary L. Bates, Rochester, MN (US); Steven G. Halverson, Rochester, MN (US); John M. Santosuosso, Rochester, MN (US)

Correspondence Address: IBM CORPORATION, INTELLECTUAL PROPERTY LAW;DEPT 917, BLDG. 006-1, 3605 HIGHWAY 52 NORTH, ROCHESTER, MN, 55901-7829, US

(73) Assignee: INTERNATIONAL BUSINESS MACHINES CORPORATION, ARMONK, NY (US)

(21) Appl. No.: 11/239,621

(22) Filed: Sep. 29, 2005

(51) Int. Cl. G06F 9/44

(52) U.S. Cl. 717/124

(57) ABSTRACT

A method and apparatus for debugging the source code of a computer program are provided. A debugging system typically provides step into and step over commands that allow for the stepwise execution of a computer program. Embodiments of the invention allow users to specify lines of source code at which to override a step over command and instead perform a step into command. Further, a debugging system configured according to the present invention may analyze user activity or the program being debugged to identify locations in the source code where a programmer may prefer to step into a function call, rather than perform a step over operation.

### BACKGROUND OF THE INVENTION

1. Field of the Invention

The present invention generally relates to software development. More particularly, the invention is directed to techniques for debugging the source code of a computer program.

2. Description of the Related Art

A programmer usually develops a software program using a text editor to create source code files. From these source code files, an executable program is generated by translating the source code files into an executable program. The process of generating the executable program from the source code usually involves the use of several software programs. For example, a compiler program may be used to generate a set of object code modules from the source code file, and a linker may be used to link the modules together to form the executable program.

It is not uncommon for the source code files of a computer program to include thousands, if not millions, of lines of source code, often spread across many files. Because of this complexity, software programs often contain errors that manifest themselves during program execution (commonly referred to as bugs). Accordingly, a debugging tool has become an essential tool of software development. Typically, a debugger program allows a developer to monitor the execution of a computer program. Doing so assists a programmer in finding and correcting errors. A typical debugging system includes a combination of computer hardware and debugger software that executes the program being debugged in a controlled manner. For example, a user interface provided for the debugger typically allows a user to set breakpoints at lines of code. During program execution, when the executing program encounters a breakpoint, the program ceases executing and turns control over to the debugger, allowing the developer to examine the state of the program at the breakpoint.

Additionally, debuggers often provide a variety of other debugging commands that allow a user to control the execution of a program. For example, one common debugger command allows a user to “step” though lines of source code, executing the program line-by-line. When a user issues a step command, the program executes the machine instructions corresponding to the line of source code based on the current execution point of the program, and advances the execution point to the next line of source code. Step commands typically take one of two forms: step into and step over. A step over command causes the program to execute the current line of code and set the execution point of the program to the next line of source code. If the line of code contains a function call (i.e., it invokes a routine or method defined by the program), then the program executes all of the instructions specified by the function. In contrast, the step into command will set the execution point of the program to the first line of code for the function, allowing a programmer to step through each of the instructions specified by the function.

One common frustration users experience when debugging a program is inadvertently causing the program to execute beyond a desired execution point. For example, this may occur when a user enters a step command causing the program to step over a routine they intended to step into. This is a particularly common experience when using a debugger that includes a type-ahead buffer that buffers step commands. Overstepping a desired execution point is also a problem where a parameter of a function call is itself a function call. In order for a user to step into the function call, a programmer must first step into the function called as a parameter. Another common frustration experienced by programmers occurs when a program must execute for long periods of time before invoking the debugger. If a user issues an untimely step command while debugging the program, the program must be restarted, requiring the programmer to wait until the program again reaches the desired execution point (where the same mistake can again occur).

Accordingly, there remains a need for improved techniques for debugging source code. For example, there remains a need for a debugging system configured to respond to user step commands in a manner that reduces the likelihood that a user will inadvertently case a program being debugged to proceed past a desired execution point.

### SUMMARY OF THE INVENTION

The present invention generally provides methods for controlling the execution of a program while debugging code. The method generally includes presenting a debugger interface displaying the source code for a program being debugged and an execution point to a user. In one embodiment, the execution point indicates the next line of source code that will be executed. Users interact with the interface to request the debugger to perform actions, such as executing lines of code and setting breakpoints. Additionally, users may specify lines of code at which to override a step over and instead perform a step into command. Further, the debugger may be configured to analyze user activity or the program being debugged to identify locations in the source code where a programmer may prefer to step into a function call, rather than perform a step over operation.

One embodiment provides a method for debugging the source code of a computer program using an interactive debugging system. The method generally includes initiating a debugging session, wherein the debugging session is configured to allow a user to control the step-wise execution of the computer program by issuing step over and step into commands, and selecting a location in the source code at which to override a step over command issued to the debugging system. The method generally further includes, in response to a step over command issued at the selected location, during the subsequent step-wise execution of the computer program, overriding the step over command by performing an alternative action. In various embodiments, the selected location may be identified by a name associated with a function call present in the source code at the selected location, and the selected location may include each line of source code in which the selected function call is present. Alternatively, a user may select a location in the source code by specifying particular lines of source code (e.g., by line number) in the program at which to perform an alternate action to an issued step over command.

In addition to user selected locations, in one embodiment, the method may be configured to identify locations in the source code where a user may wish to have an alternate action performed in response to a step over command. In such a case, the alternate action may include, displaying a prompt, prior to executing the step over command that allows the user to selectively override a step over command. After a brief period, such a prompt may time-out of its own accord.

Another embodiment of the invention provides a computer-readable medium containing a program which when executed by a processor, performs operations for debugging the source code of a computer program using an interactive debugging system. The operations may generally include, initiating a debugging session, wherein the debugging session is configured to allow a user to control the step-wise execution of the computer program by issuing step over and step into commands, selecting a location in the source code at which to override a step over command issued to the debugging system, and in response to a step over command issued at the selected location during the subsequent step-wise execution of the computer program, overriding the step over command by performing an alternative action.

Another embodiment of the invention includes a computing device. The computing device may include a processor, and a memory configured to store an application that includes instructions which, when executed by the processor, cause the processor to provide an interactive debugging system by performing operations. The operations may generally include initiating a debugging session, wherein the debugging session is configured to allow a user to control the step-wise execution of the computer program by issuing step over and step into commands, selecting a location in the source code at which to override a step over command issued to the debugging system, and in response to a step over command issued at the selected location during the subsequent step-wise execution of the computer program, overriding the step over command by performing an alternative action.

### BRIEF DESCRIPTION OF THE DRAWINGS

So that the manner in which the above recited features, advantages and objects of the present invention are attained and can be understood in detail, a more particular description of the invention, briefly summarized above, may be had by reference to the embodiments thereof; which are illustrated in the appended drawings.

Note, however, that the appended drawings illustrate only typical embodiments of this invention and are therefore not to be considered limiting of its scope, for the invention may admit to other equally effective embodiments.

FIG. 1 is a functional block diagram illustrating a network environment including at least one computer configured for debugging the source code of a computer program, according to one embodiment of the invention.

FIG. 2 illustrates a graphical user interface for a debugger program, according to one embodiment of the invention.

FIGS. 3-5 illustrate database tables, according to one embodiment of the invention.

FIG. 6 illustrates a method for a user to set step point override locations for a program being debugged, according to one embodiment of the invention.

FIG. 7 illustrates a method for processing debugger step commands issued by a user, according to one embodiment of the invention.

FIG. 8 illustrates one embodiment of a function call stack.

FIG. 9 illustrates a method for a debugger to set step point override locations for a program being debugged, according to one embodiment of the invention.

FIG. 10 illustrates a method for processing debugger step commands issued by a user, according to one embodiment of the invention.

FIGS. 11-12 illustrate an exemplary graphical user interface for a debugger program, according to one embodiment of the invention.

### DETAILED DESCRIPTION OF THE PREFERRED EMBODIMENTS

Embodiments of the invention generally include a method, computer readable medium, and apparatus that provide a debugging system configured to assist users debugging the source code of a computer program.

One embodiment of the invention provides a method for determining the action a debugger program should take in response to a user step requests. For example, users may specify lines of source code at which to override a step over command, and instead perform a step into command. Doing so may prevent a user from inadvertently issuing a step over command while later using the debugger to step through the code line-by-line.

Additionally, the debugger may be configured to identify locations in the source code of a computer program where a user may desire to step into a function, rather than step over one. For example, the debugger may monitor what function calls were on the stack when an unhandled exception occurred. While subsequently executing the program during a debugging session, the debugger may modify the response to a step over command. For example, a user interface may indicate to a user that a function call at the current execution point corresponds to the point where an unhandled exception occurred during a prior execution of the program. For example, the debugger may display a dialog box allowing a user a step into the current line of source code, rather than a step over it. After a brief period, if the user takes no action the step over is performed. Doing so provides a user with a second chance at executing a step into command for at least some lines of source code.

In the following, reference is made to embodiments of the invention. However, it should be understood that the invention is not limited to specific described embodiments. Instead, any combination of the following features and elements, whether related to different embodiments or not, is contemplated to implement and practice the invention. Furthermore, in various embodiments the invention provides numerous advantages over the prior art. However, although embodiments of the invention may achieve advantages over other possible solutions and/or over the prior art, whether or not a particular advantage is achieved by a given embodiment is not limiting of the invention. Thus, the following aspects, features, embodiments and advantages are merely illustrative and are not considered elements or limitations of the appended claims except where explicitly recited in a claim(s). Likewise, reference to “the invention” shall not be construed as a generalization of any inventive subject matter disclosed herein and shall not be considered to be an element or limitation of the appended claims except where explicitly recited in a claim(s).

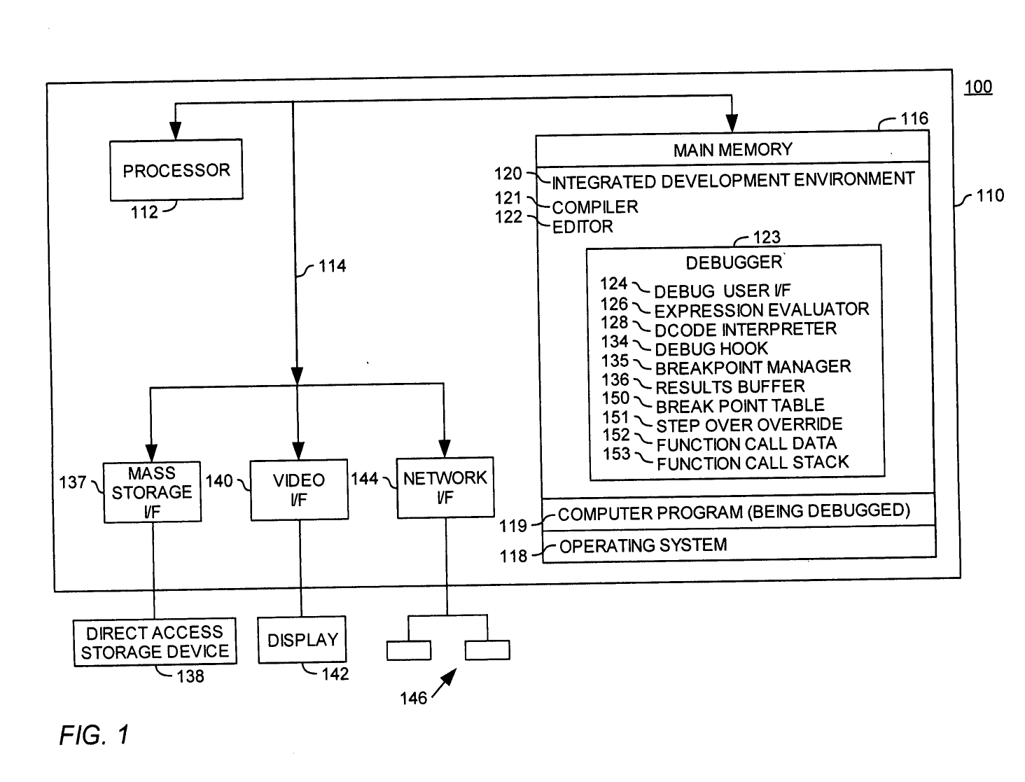

One embodiment of the invention is implemented as a program product for use with a computer system such as, for example, the commuting environment 100 shown in FIG. 1 and described below. The program(s) of the program product defines functions of the embodiments (including the methods described herein) and can be contained on a variety of signal-bearing media. Illustrative signal-bearing media include, but are not limited to: (i) information permanently stored on non-writable storage media (e.g., read-only memory devices within a computer such as CD-ROM disks readable by a CD-ROM drive); (ii) alterable information stored on writable storage media (e.g., floppy disks within a diskette drive or hard-disk drive); and (iii) information conveyed to a computer by a communications medium, such as through a computer or telephone network, including wireless communications. The latter embodiment specifically includes information downloaded from the Internet and other networks. Such signal-bearing media, when carrying computer-readable instructions that direct the functions of the present invention, represent embodiments of the present invention.

In general, the routines executed to implement the embodiments of the invention, may be part of an operating system or a specific application, component, program, module, object, or sequence of instructions. The computer program of the present invention typically is comprised of a multitude of instructions that will be translated by the native computer into a machine-readable format and hence executable instructions. Also, programs are comprised of variables and data structures that either reside locally to the program or are found in memory or on storage devices. In addition, various programs described hereinafter may be identified based upon the application for which they are implemented in a specific embodiment of the invention. However, it should be appreciated that any particular program nomenclature that follows is used merely for convenience, and thus the invention should not be limited to use solely in any specific application identified and/or implied by such nomenclature.

FIG. 1 illustrates a computing environment that includes at least one computer configured for debugging the source code of a computer program, according to one embodiment of the invention. As illustrated, the computing environment 100 includes a computer system 110 and a plurality of networked devices 146. For simplicity, only the details of the computer system 110 are shown. In one embodiment, the components provided by environment 100 include computer software applications executing on existing computer systems, e.g., desktop computers, server computers, laptop computers, tablet computers, and the like. The debugging system described herein, however, is not limited to any currently existing computing environment, and may be adapted to take advantage of new computing systems as they become available. Further, although shown networked into a larger system, the computer system 110 may be a standalone device. Embodiments may also be adapted to a distributed computing environment in which tasks are performed by remote processing devices that are linked through a communications network.

Illustratively, the computer system 110 is shown including a mass storage interface 137 connected to direct access storage device 138, a video interface 140 connected to a display 142, and a network interface 144 connected to computer network 146. The display 142 may be any video output device configured to display visual images to a user of the debugging system disclosed herein. Computer system 110 is shown with at least one processor 112, which obtains instructions and data via a bus 114 from a main memory 116.

The main memory 116 provides a sufficiently large storage area to store the programs and data structures required by the present invention. Main memory 116 could be one or a combination of memory devices, including Random Access Memory, nonvolatile or backup memory, (e.g., programmable or flash memories, read-only memories, etc.). In addition, memory 116 may include memory physically located elsewhere in a computer system 110. For example, memory may include any storage capacity used as virtual memory or stored on a mass storage device or on another computer coupled to the computer system 110 via bus 114.

As shown, the main memory 116 generally includes an operating system 118, a computer program 119 and an Integrated Development Environment (IDE) 120. The computer program 119 represents the program being debugged using IDE 120. Accordingly, the computer 119 may include both the source code for computer program 119, and a machine-readable version of the code executed by processor 112. Illustratively, the IDE 120 includes a compiler 121, an editor 122 and a debugger program (sometimes referred to as ‘she debugger’) 123. More generally, the IDE 120 provides a combination of software programs, data structures, and any associated utilities for editing, compiling and locating, analyzing and correcting errors in the source code of the computer program 119. The IDE 120, however, is merely illustrative.

Further, although the software elements illustrated in FIG. 1, such as the computer program 119 and the debugger 123, are shown residing on the same computer, a distributed environment is also contemplated. Thus, for example, the debugger 123 may be located on a networked device 146, while the computer program 119 to be debugged is on the computer system 110.

In various embodiments, the debugger 123 may include a number of components. Illustratively, debugger 123 includes a debugger user interface 124, expression evaluator 126, Dcode interpreter 128 (also referred to herein as the debug interpreter 128), debugger hook (also known as a stop or breakpoint handler) 134, a breakpoint manager 135, a results buffer 136, a breakpoint table 150, a step into data table 151, a function call data table 152, and a function call stack 153. Although treated herein as integral components of the debugger 123, one or more of the foregoing components may exist separately in the computer system 110. Further, the debugger 123 may include additional components not shown.

In one embodiment, a user initiates the debugging process by interacting with the user interface 124. The user interface 124 may display the program being debugged and highlight the current execution point of the program 119, relative to the source code. In addition, the interface 124 may display information about other locations within the source code, e.g., breakpoints, step point overrides, or other or other information used to convey the state of the program during a debugging session. The user interface 124 may be configured to allow a user to set control points (e.g., breakpoints, watch points, and alternate step points), display and change values for variables of the program 119, and activate and control other features described herein.

After initiating a debugging session, a user may cause debugger 123 to begin executing program 119. During execution, when a breakpoint is encountered, control is returned to the debugger 123 via the debug hook 134. The debug hook 134 includes instructions returning control to the debugger 123. In one embodiment, the debug hook 134 may be configured to invoke the debug user interface 124 and may pass information about the execution state of program 119 to the interface 124. Alternatively, information may be passed to the results buffer 136 to cache data for the user interface 124. While the debugger has control, a user may issue individual step commands (e.g., step into, and step over), to execute the computer program, one line of code at a time. Additionally, the user may input commands to run a desired debugging routine, inspect the state of data associated with the program being debugged, or perform other debugging actions.

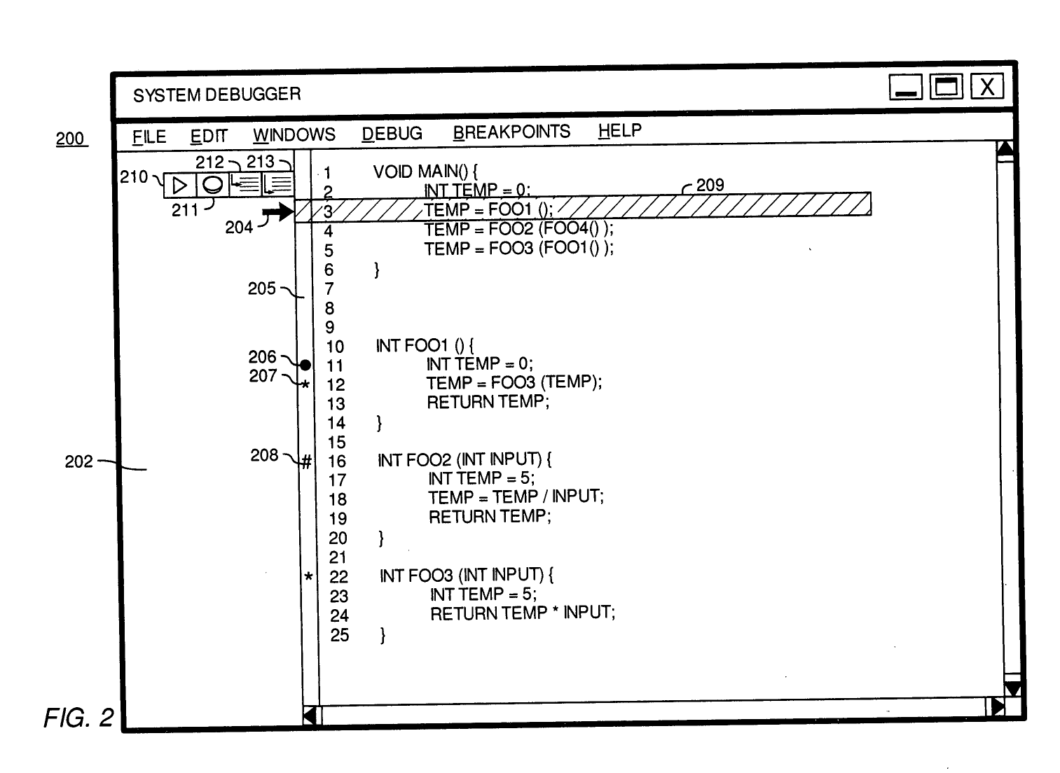

FIG. 2 illustrates an exemplary graphical user interface (GUI) 200, according to one embodiment of the invention. The GUI 200 is illustrative of the debug user interface 124, and may be rendered on an output device such as the display 142. In one embodiment. The GUI 200 includes a viewable screen area 202 that displays the source code of the computer program 119 being debugged. The source code may be formatted in a variety of way to convey meaningful information to a user viewing the source code (e.g., indentations, source code highlighting etc.). Additionally, FIG. 2 illustrates an arrow 204 next to line 3 of the source code. The arrow 204 indicates the current execution point of the program 119. Thus, in this example, the program 119 has executed lines 1 and 2, and line 3 will be the next line of the program 119 executed.

In one embodiment, the GUI 200 includes control elements for issuing debugger commands (e.g., step into and step over commands) and may further include elements for setting watch points, breakpoints, step point overrides, etc. As illustrated, the interface 200 includes four buttons, a start button 210, stop button 211, a step into button 212 and a step over button 213. The start button 210 may be used to resume execution of the program from the current execution point indicated by the arrow 204. The stop button 211 may be used to stop or interrupt the execution of the program 119.

Illustratively, the step into button 212 allows a user to issue a step into command, and step over button 213 allows the user to issue a step over command. As described above, a step into command instructs the debugger to execute the next line of source code, but to step into the first function call (if any) present in the line of source code. In contrast, the step over command instructs the debugger to execute the current line of source code, including any function calls, and pause execution at the next sequential line of source code.

For example, the execution point of the program 119 illustrated in FIG. 2 is currently stopped at line 3. This line includes a function call to the function foo1( ) which returns a value assigned to the “temp” variable. Depending on whether a step over or step into command is issued, the debugger will perform the following actions: a step into command will “step into” the foo1( ) function and set the execution point of the program to the first line of the foo1( ) function (line 10). Alternatively, a step over command will cause the debugger 123 to execute the foo1( ) function, set the value of temp to the value returned by the foo1( ) function, and increment the execution point to line 4.

In one embodiment, however, the behavior of the debugger just described may be modified to account for instances where a user may inadvertently issue a step over command, when a step into is, in fact, desired. Additionally, the debugger 123 may be configured to predict locations within the source code being debugged where a user may desire to step into a function call, rather than step over one. For example, the debugger 123 may be configured to present a user with the opportunity to override a just issued step over command and, instead perform a step into command.

The GUI 200 illustrates breakpoints and alternate step points (i.e., a step point override) specified for the column using the symbols listed in column 205. In one embodiment, a user defines breakpoints and alternate step points by interacting with the debugger interface 124. Illustratively, at line 11, the trap column 205 includes a circle icon (●) used to represents a user-defined breakpoint 206. Accordingly, if a user issues a run command (using button 210) the program 119 would execute until reaching this line. The trap column 205 displays a star icon (*) at line 12, used herein to represent a step point override location. If the user issues a step command at line 12, the debugger overrides this command and instead performs a step into. At line 16, the pound (#) icon 208 is used herein to represent a step point override set by the debugger. Thus, the (*) and (#) icons both represent step point override locations. In one embodiment, however, the debugger 123 distinguishes between a step point override, set by a user with a step point override set by the debugger. The use and operation of the debugger 123 regarding each of these constructs is described in greater detail below. Additionally, the symbols (●, *, and #) used to represent the breakpoint 206 and step points overrides 207 and 208, are arbitrary and used solely to illustrate the present invention.

Additionally, in one embodiment the interface 124 may provide an additional GUI control element to override the override. For example, interface 124 may include an additional step button to perform a step over at a line location for which a step point override has been set, e.g., as indicated by the (*) at line 12 of the source code illustrated in FIG. 2.

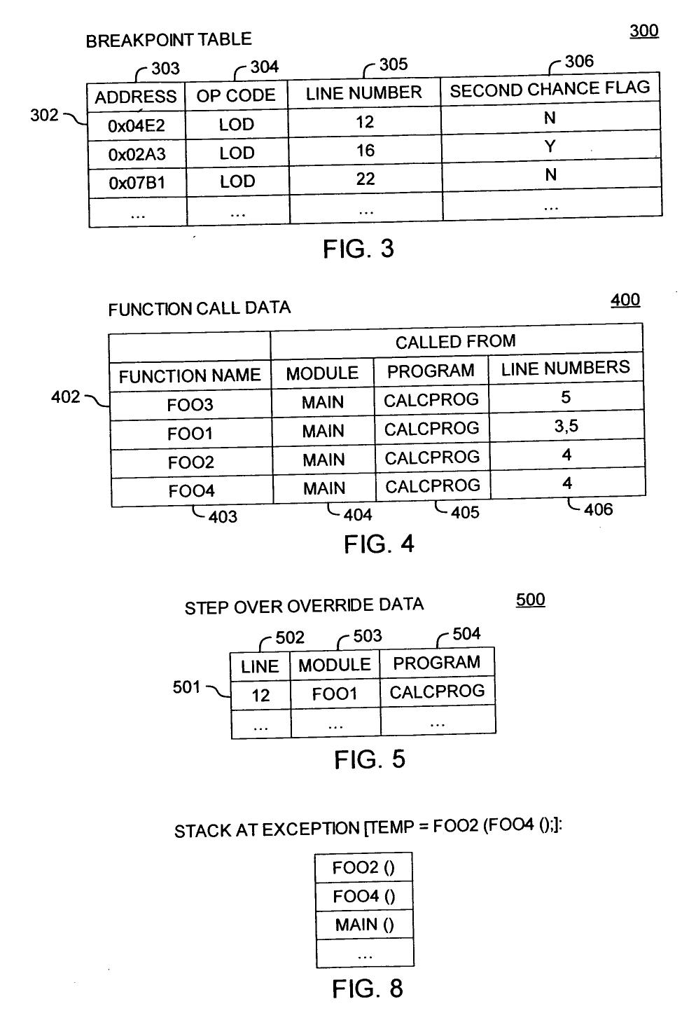

In one embodiment, the debugger may store information regarding the step point overrides, breakpoints, etc., using a data structure such as a table. FIGS. 3-5 illustrate an exemplary collection of tables for storing step point override data.

First, FIG. 3 illustrates one embodiment of the breakpoint table 150. This table stores information about all the breakpoints currently set for a program being debugged. Illustratively, the breakpoint table 150 includes a plurality of columns and rows, where each row defines a record. For simplicity, only a few records are shown. A record 302 defines the breakpoint. The address column 303 stores the address of the breakpoint in the main memory 116. The OP Code column 304 contains the machine instruction code that occurs at the breakpoint. The line number column 305 contains the line number that corresponds to the line number location of the breakpoint in the source code. The column 306 identifies whether a breakpoint is a step point override set by the debugger. That is, it indicates whether the breakpoint was set by debugger as a location within source code that a user may prefer to step through using step into command, instead of a step over. As described below, these breakpoint may be used to give a user a second chance to step into certain function calls in response to a step into command.

Second, FIG. 4 illustrates one embodiment of a function call data table 152. For each function defined in a program, this table identifies all of the locations in the source code where the function is called. Illustratively, the function call data table 152 is a plurality of columns and rows, where each row defines a record. For simplicity, only a few records are shown. A record 402 contains information about a function call in the source code 119. The function name column 403 stores the name of the function. The module column 404 contains the name of the module in which the function call occurs. The program column 405 contains the name of the routine in which the function call occurs. Column 406 lists the lines of source at which the function call occurs.

Finally, FIG. 5 illustrates one embodiment of the step point override table 151. The table 151 identifies line locations in the source code where a user has selected to set a step point override. As described above, a step point override will cause the debugger to override a step over command issued by a user, and instead perform a step into command at the source code location specified by the step point override. In one embodiment, the step point override table 151 includes a plurality of columns and rows, where each row defines a record. For simplicity, only a few records are shown. A record 501 stores information about a particular step point override. The line column 502 stores the source code line number corresponding to the override step point. The module column 504 stores the name of the module containing the override step point. The program column 505 stores the name of the program corresponding to the override step point.

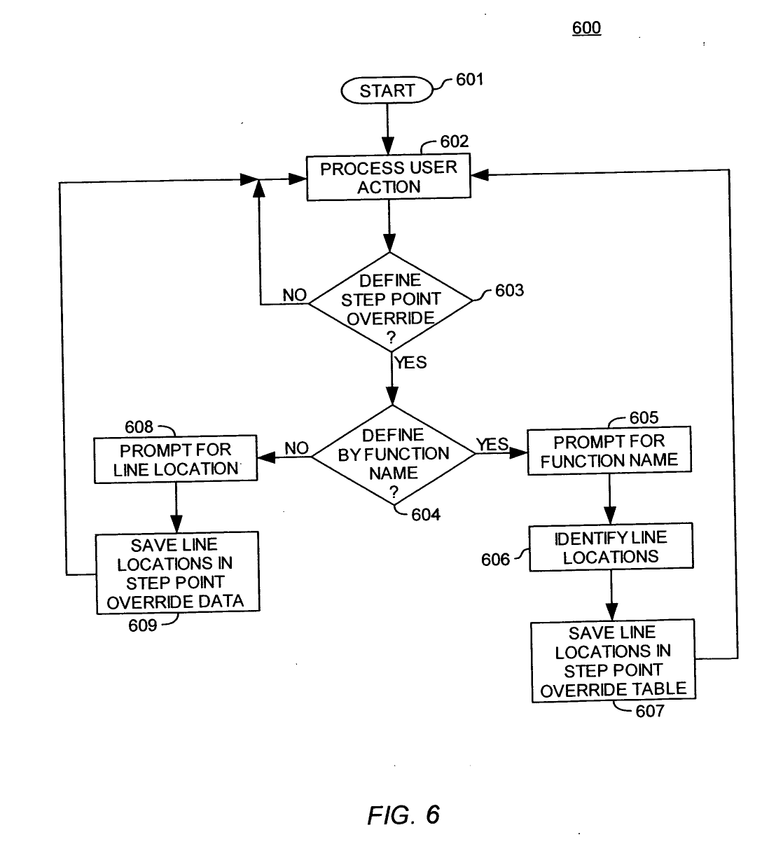

FIG. 6 illustrates a method 600 for setting an override step point in a program being debugged, according to one embodiment of the invention. In one embodiment, the method 600 may be used to identify source code locations to override a step over command. A debugger 123 configured to perform method 600 begins at step 601 and proceeds to step 602 to process a user action. At step 603, the debugger 123 determines whether the user action is to define a step point override. If so, then the debugger 123 proceeds to step 604. Otherwise, the debugger 123 returns to step 602, and processes other user actions.

At step 604, the debugger 123 determines if the user is defining the step point override by function name. That is, the debugger 123 determines whether the step point override should be applied to each instance of a function call in program 119. If so, then at step 605, the debugger 123 obtains the function name from the user. The method 600 then continues to step 606, where the debugger 123 retrieves from the function call table 402 the line locations 406 for all records 402 where the function name column 403 matches the function name identified by the user. The method 600 proceeds to step 607 where the debugger 123 records all the line locations retrieved at step 606 into the override step table 500. Finally, the debugger 123 returns to step 602 where it processes the next user action.

At step 604, if the step point override is not being set for each instance of a function call, the debugger 123 assumes that the user is defining the override step point by line number. If so, the debugger 123 continues to step 608, where the debugger 123 obtains the selected line location at which to place the step point override. The method 600 then proceeds to step 609 where the debugger 123 records the line location in table 500. Finally, after completing steps 607 or 609, the debugger 123 returns to step 602 where it processes the next user action. Once a user defines a step point override, any step command issued at the selected line or function will cause the debugger 123 to perform a step into command.

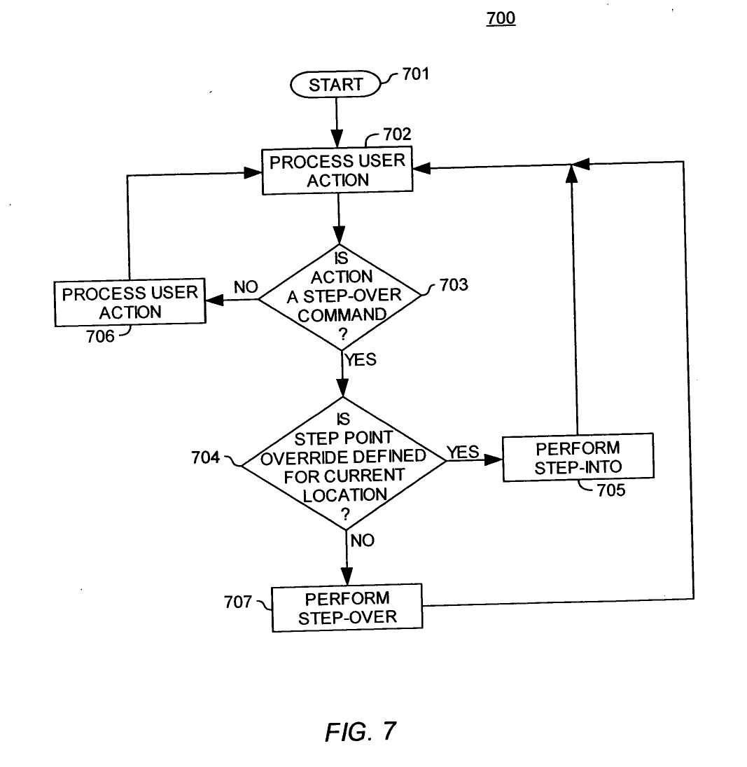

Once a step override is set, if the user issues a step over command for a location where a step point override has been set then, the debugger 123 ignores a step over command and instead performs a step into for the current execution point. For example, FIG. 7 illustrates a method 700 for a debugger 123 to process step commands issued by a user, according to one embodiment of the invention. A debugger 123 configured to perform method 700 begins at step 701 and proceeds to step 702 to process a user action. At step 703 the debugger 123 determines whether the user action is a step command. If so, the method proceeds to step 704. Otherwise, the method 700 returns to step 702.

At step 704, when a user issues a step command, the debugger 123 searches the table 500 for a record in which the entry in the line number column matches the current execution point of the program 119 being debugged. If the debugger 123 finds a match, then the debugger 123 continues to step 705, where the debugger 123 performs a step into action. Otherwise, the debugger 123 proceeds to step 707, where the debugger 123 performs a step over action. After performing the appropriate step action, the method 700 returns to step 702, where the debugger 123 continues to process user actions received from the debugger user interface 124.

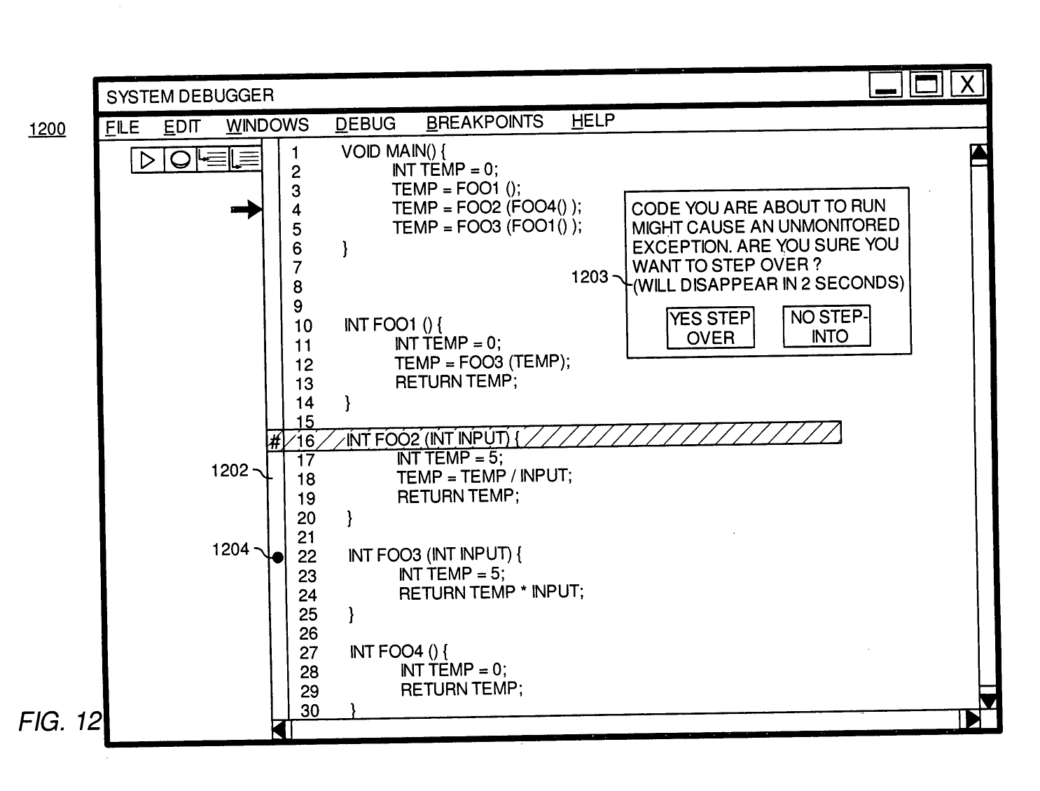

FIG. 11 illustrates an exemplary GUI screen corresponding to the operations of method 700, according to one embodiment of the invention. Illustratively, a user has set a breakpoint at line 10, and a step point override at line 12 1102. After beginning a debugging session, the debugger 123 halts execution of the program 119 at line 10 (upon reaching breakpoint 1101). At this point, suppose a user issues two step into commands using button 213. In response, the debugger 123 executes lines 10 and 11, and halts execution at line 12. If at this point the user issues a step over command, when the debugger 123 searches the override step point table 500, it finds a record in which the entry in the line number column 502 is 12. Since the debugger 123 finds a matching record, it will perform a step into instead of a step over. Accordingly, even though the user issued a step over command, a step into command is performed pausing execution of the computer program at line 22.

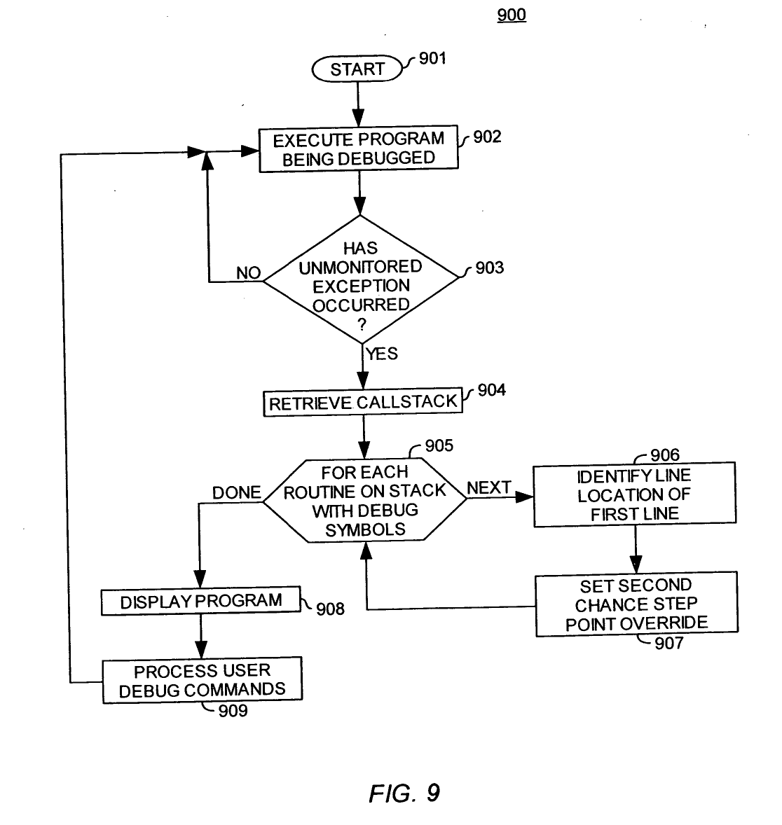

As described above, in one embodiment, the debugger 123 may be configured to identify locations in the program 119, where a user may be interested in stepping into a function call, rather then stepping over. For example, this may occur for functions that have previously caused the program 119 to crash, or for functions that a user has decided to step into during prior debugging sessions. FIGS. 8-10 and 12 illustrate one such embodiment.

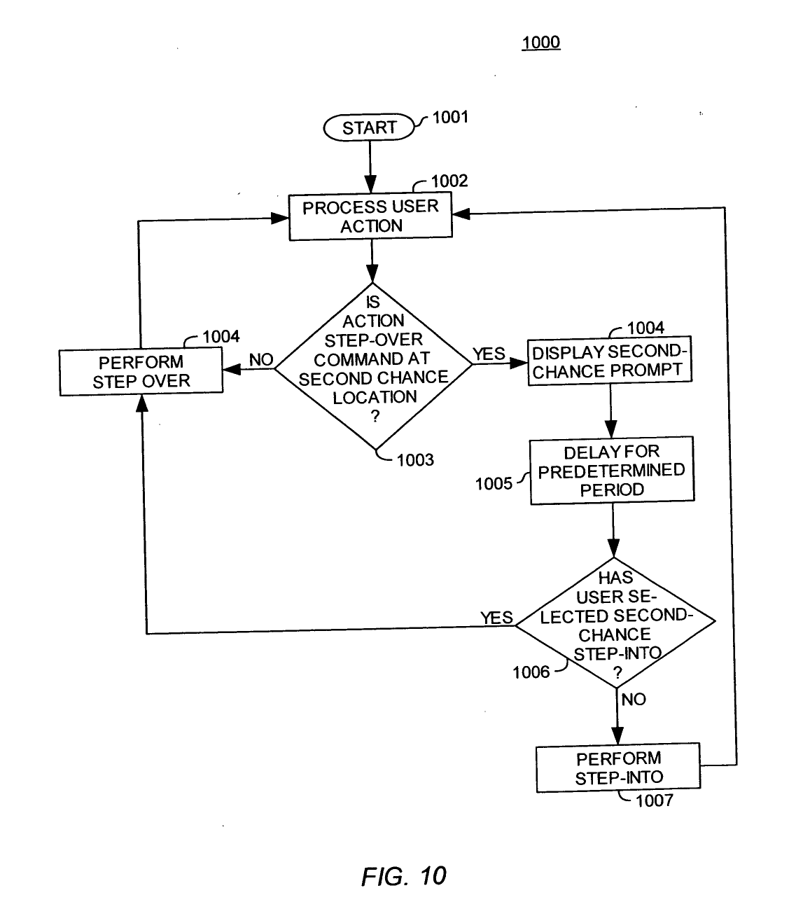

FIG. 9, illustrates a method 900 for debugger 123 to select locations in the program being debugged at which to set step point overrides, according to one embodiment of the invention. A debugger 123 configured to perform method 900 begins at step 901 and proceeds to step 902 to execute a program being debugged, up to either a break point or until the program crashes as a result of an unmonitored exception. At step 903 the debugger 123 determines whether the execution of program 119 has caused an unmonitored exception. If so, then the debugger 123 proceeds to step 904. Otherwise, the debugger 123 returns to step 902, where it processes the next user action.

When an unmonitored exception occurs, at step 904, the debugger 123 examines a function call stack for the program being debugged. For each routine on a function call stack, the debugger 123 retrieves the line number of the first statement of the routine 906, and enters a record into the breakpoint table 300 that includes the address, op code, and line number of the first statement of the routine. The flag 907 for this record 302 is set to true. After the debugger 123 enters records for all routines on the function call stack 153 into the breakpoint table 300, the debugger 123 proceeds to step 909, where the debugger 123 retrieves the next user action. Then, the debugger 123 returns to step 902 where the debugger 123 processes the user action.

FIG. 8 illustrates one embodiment of a function call stack 153. As the program being debugged calls different functions, the function name is placed on the top of the stack. After the program being debugged exits a function, the debugger 123 removes the function name from the top of the stack. In the event an unmonitored exception occurs, the debugger can use the function call stack 153 to determine which function the error occurred in, and what functions the program called prior to the program crashing.

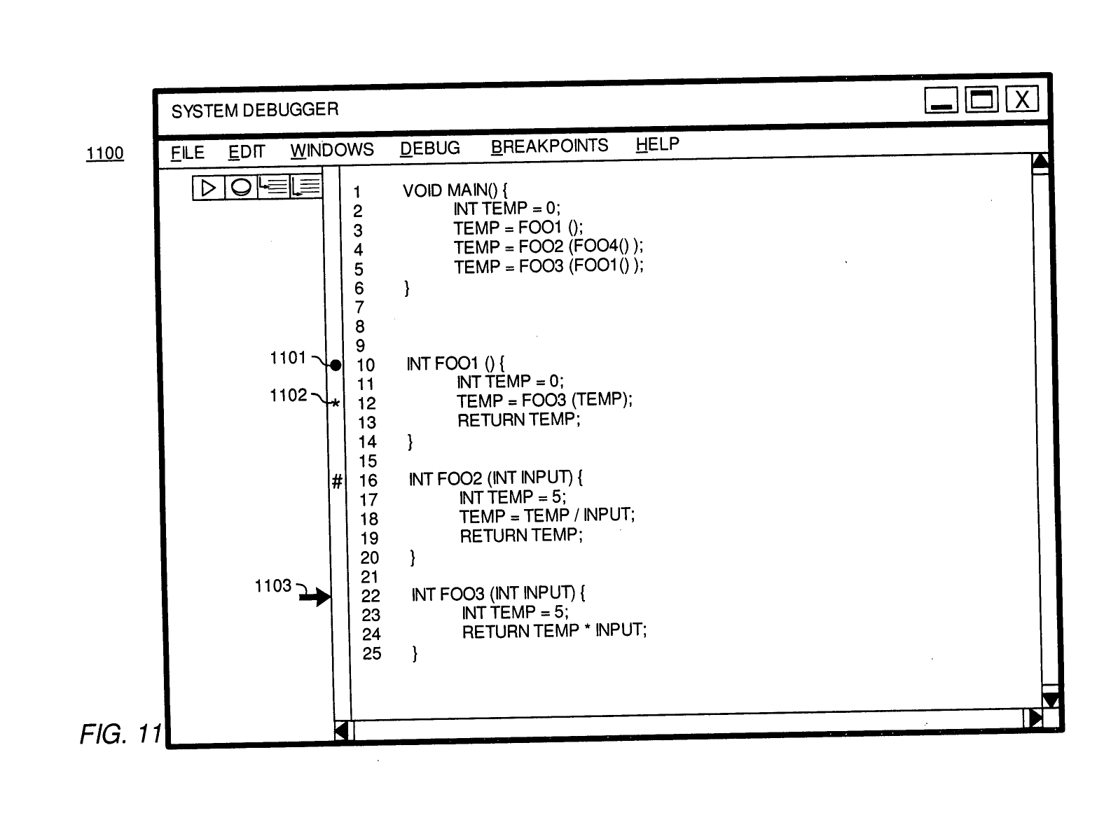

FIG. 10 illustrates a method 1000 for processing a step point override set by the debugger 123, according to one embodiment of the invention. The method 1000 begins at step 1001 and proceeds to step 1002, where the debugger 123 processes a user action. At step 1003, the debugger 123 determines whether the user action is a step over command issued during program execution on a line number that matches a record 302 in the breakpoint table 300 where the step point override flag 306 is true. If not, then the debugger 123 processes the user action normally 1004, and returns to step 1002. Otherwise, when the debugger 123 finds a matching record 302, in the breakpoint table 300 where the choice step point flag 306 is set, then the GUI 200 displays a prompt asking whether the user wants to step into instead of step over the current line 204. For example, in one embodiment, the GUI 200 will display the prompt for a brief amount of time while waiting for user input 1005. At step 1006, the debugger 123 determines whether the user decided to perform a step into instead of a step over. If so, the debugger 123 performs a step into and the debugger 123 will return to step 1002, where it processes the next user action. If the user confirms to perform a step over, or if the delay for user input times out, then method 1000 proceeds to step 1004, where the debugger 123 executes the requested user action, and then returns to step 1002 to process the next user action.

FIG. 12 illustrates an exemplary GUI screen corresponding to the operations of method 1000, according to one embodiment of the invention. FIG. 12 illustrates the GUI for a debugger defined step override. Compare this with FIG. 11, which illustrates a GUI screen for a user defined step override (set according to the method of FIG. 7). In one embodiment, a user defined override is always performed, and a debugger defined override may be optionally performed according to user discretion. Specifically, FIG. 12 illustrates the operations of the method 1000 to respond to a step over command issued for a program location for which a step point override has been set by the debugger 123. Illustratively, the GUI interface 200 of debugger 123 has set a step point override set at line 16. This may occur, for example, in response to an unmonitored divide by zero exception at line 18 1202 encountered during a prior debugging session. When a subsequent execution the program 119 reaches line 16 1204, the step point override defined for this line will modify the actions of debugger 123 responding to a step over command.

For example, in one embodiment, the debugger 123 will display a prompt 1204 asking the user to confirm the step over command, and informing the user that the prompt will disappear after a specified period of time. In this embodiment, the timeout before the prompt disappears is 2 seconds, but this can be any period of time. If the user presses the step confirm button 1205, or the timeout period elapses, then the prompt will disappear, and the debugger 123 will execute the step over command by executing the line “temp=foo2(foo1( ));” and setting the execution point of the program 119 to line 5. Thus, the step over command will cause all of the instructions defined by both foo2( ) and foo1( ) to be executed. Alternatively, if the user decides to perform a step into the code by pressing the step override button 1206 before the timeout period elapses. In response, the debugger 123 will advance the execution point of the program 119 being debugged to line 16, the first line of the foo1( ) function call.

### CONCLUSION

Embodiments of the invention provide a debugging system configured to detect when a step over command should be interpreted (or overridden) as a step into command. One embodiment allows a user to select functions, routines, or specific source code locations that should be stepped into when encountered. Thus, if the user attempts to issue a normal step command when stopped at a selected location, the resulting action will be a step into rather than a step over. In another embodiment, the debugger may be configured to detect locations in the source code where a step into may be preferred to a step over, e.g., based on user or program patterns, such as which routines where on the call stack when the last unmonitored exception occurred. Based on these patterns a debugger configured according to the present invention flags functions that the user may want to step into. Further, in one embodiment, these debugger selected locations may not automatically override a step over command issued by a user. For example, when a user issues a step function to step over one of these routines the debugger may display a reminder, allowing the user a second chance to step into a routine. After a predetermined amount of time, the second chance may expire and the step over command will be performed.

While the foregoing is directed to embodiments of the present invention, other and further embodiments of the invention may be devised without departing from the basic scope thereof, and the scope thereof is determined by the claims that follow.

What is claimed is:

1. A computer-implemented method for debugging the source code of a computer program using an interactive debugging system, comprising:
initiating a debugging session, wherein the debugging session is configured to allow a user to control the step-wise execution of the computer program by issuing step over and step into commands;
selecting a location in the source code at which to override a step over command issued to the debugging system; and
in response to a step over command issued at the selected location during the subsequent step-wise execution of the computer program, overriding the step over command by performing an alternative action.

2. The method of claim 1, wherein selecting a location in the source code comprises identifying a name associated with a function call preset in the source code, and wherein the selected location comprises each line of source code that includes the function call.

3. The method of claim 1, wherein selecting a location in the source code comprises selecting at least one line of source code in the program that includes a selected function call.

4. The method of claim 1, wherein the alternate action is to perform a step into command for a function call present in the source code at the selected location.

5. The method of claim 1, wherein the alternate action comprises, displaying a prompt, prior to executing the step over command, that allows the user to selectively override the step over command issued at the selected location.

6. The method of claim 5, wherein the prompt is configured to time-out after a specified period of time.

7. The method of claim 1, wherein selecting a location comprises identifying function calls in the source code for which the user may prefer to step into the function calls rather than step over the function calls.

8. The method of claim 7, wherein the identified function calls correspond to function calls present on a stack at the time of an unhandled exception occurring during a prior execution of the program.

9. The method of claim 7, wherein the identified function calls are selected by the debugging system according to aspects of the computer program that are monitored by the debugging system.

10. A computer-readable medium containing a program which when executed by a processor, performs operations for debugging the source code of a computer program using an interactive debugging system, comprising:
initiating a debugging session, wherein the debugging session is configured to allow a user to control the step-wise execution of the computer program by issuing step over and step into commands;
selecting a location in the source code at which to override a step over command issued to the debugging system; and
in response to a step over command issued at the selected location during the subsequent step-wise execution of the computer program, overriding the step over command by performing an alternative action.

11. The computer-readable medium of claim 10, wherein selecting a location in the source code comprises identifying a name associated with a function call preset in the source code, and wherein the selected location comprises each line of source code that includes the function call.

12. The computer-readable medium of claim 10, wherein selecting a location comprises selecting at least one line of source code in the program that includes a selected function call.

13. The computer-readable medium of claim 10, wherein the alternate action is to perform a step into command for a function call present in the source code at the selected location.

14. The computer-readable medium of claim 10, wherein the alternate action comprises, displaying a prompt, prior to executing the step over command, that allows the user to selectively override the step over command issued at the selected location.

15. The computer-readable medium of claim 13, wherein the prompt is configured to time-out after a specified period of time.

16. The computer-readable medium of claim 10, wherein selecting a location comprises identifying function calls in the source code for which the user may prefer to step into the function calls rather than step over the function calls.

17. The computer-readable medium of claim 16, wherein the identified function calls correspond to function calls present on a stack at the time of unhandled exception occurring during a prior execution of the computer program.

18. The computer-readable medium of claim 16, wherein the identified function calls are selected by the debugging system according to aspects of the computer program that are monitored by the debugging system.

19. A computing device comprising:
a processor; and
a memory configured to store an application that includes instructions which, when executed by the processor, cause the processor to provide an interactive debugging system for debugging the source code of a computer program, by performing at least the steps of:
initiating a debugging session, wherein the debugging session is configured to allow a user to control the step-wise execution of the computer program by issuing step over and step into commands;
selecting a location in the source code at which to override a step over command issued to the debugging system; and
in response to a step over command issued at the selected location during the subsequent step-wise execution of the computer program, overriding the step over command by performing an alternative action.

20. The computing device of claim 19, wherein the alternate action is to perform a step into command for a function call present in the source code at the selected location.

21. The computing device of claim 19, wherein the alternate action comprises, displaying a prompt, prior to executing the step over command, that allows the user to selectively override the step over command issued at the selected location.
